(19) United States
(12) Patent Application Publication
(10) Pub. No.: US 2004/0001453 A1
(43) Pub. Date: Jan. 1, 2004

(54) Wireless type data transmission device

(75) Inventors: Sigekazu Kawai, Gunma-ken (JP); Isao Shibata, Gunma-ken (JP); Katsu Horikoshi, Gunma-ken (JP); Yutaka Saito, Saitama-ken (JP); Tsutomu Tanaka, Kanagawa-ken (JP)

Correspondence Address: McGinn & Gibb, PLLC, Suite 200, 8321 Old Courthouse Road, Vienna, VA, 22182-3817, US

(73) Assignee: Sanyo Electric Co., Ltd., Moriguchi-shi (JP)

(21) Appl. No.: 10/460,642

(22) Filed: Jun. 13, 2003

(30) Foreign Application Priority Data
Jun. 20, 2002 (JP) 2002-180402

(51) Int. Cl. G08C 17/00

(52) U.S. Cl. 370/311; 370/278

(57) ABSTRACT

A wireless type data transmission device (data carrier) has a receiver for receiving electric wave transmitted from a reader-writer, a rectifier for rectifying the received electric wave to generate a first voltage, and a booster for boosting the first voltage to produce a second voltage, which is higher than the first voltage, to drive an internal circuit of the wireless type data transmission device.

This application is based on Japanese patent application No. 2002-180402, the entire contents of which are incorporated herein by reference.

### BACKGROUND OF THE INVENTION

1. Field of the Invention

This invention relates to a wireless type data transmission device that can self-generate electric power needed to drive the internal circuits without increasing the device size.

2. Description of the Related Art

Wireless type data transmission devices that information stored in a responder (data carrier) is read and written through radio communications by using an interrogator (reader-writer) are known.

Some wireless type data transmission devices use micro wave (2.45 GHz) in transmitting and receiving data between the data carrier and reader-writer. The reader-writer sends an electric wave modulated by data based on the reading or writing command to the data carrier. The data carrier generates electric power necessary to data communications based on the received micro wave, and sends a reflected wave responding to the received data to the reader-writer.

The wireless type data transmission devices stated above, due to using the high-frequency radio wave, can suppress the lowering of communication characteristics caused by external noises and can secure a wider communication area than a short-range type with a communication area of centimeters to one meter.

However, in the conventional wireless type data transmission devices, there is a problem that the available electric power generated based on the received radio wave is limited to a small amount and, therefore, the data carrier lacks electric power to drive the internal circuits except for the transmitting and receiving circuit. To overcome this problem, the built-in battery may be enlarged in capacity according to need. In this case, the device size will be increased and will not suit the requirement that it must be miniaturized. In addition, the battery is infinite in consumed power even when enlarged and, therefore, is needed to recharge periodically by operator.

### SUMMARY OF THE INVENTION

It is an object of the invention to provide a wireless type data transmission device that can self-generate electric power to drive the internal circuits as well as the transmitting and receiving circuit without increasing the device size.

According to one aspect of the invention, a wireless type data transmission device that generates electric power based on electric wave transmitted from a transmission device, the wireless type data transmission device comprises:

means for receiving the electric wave;

means for rectifying the received electric wave to generate a voltage; and

means for boosting the voltage to produce a driving voltage to drive an internal circuit of the wireless type data transmission device.

According to another aspect of the invention, a wireless type data transmission device that generates electric power based on electric wave transmitted from a transmission device, the wireless type data transmission device comprises:

means for receiving the electric wave that is modulated according to data to be transmitted from the transmission device and for demodulating the electric wave to extract the data;

means for conducting an operation according to the extracted data;

means for rectifying the received electric wave to generate a voltage; and

means for boosting the voltage to produce a driving voltage to drive an internal circuit of the wireless type data transmission device.

### BRIEF DESCRIPTION OF THE DRAWINGS

The preferred embodiments according to the invention will be explained below referring to the drawings, wherein:

FIG. 1 is a block diagram showing the schematic composition of a wireless type data transmission device in a first preferred embodiment according to the invention;

FIG. 2 is a block diagram showing the details of a sensor 26 in FIG. 1;

FIG. 3 is a circuit diagram showing the details of a rectifier 21 and a booster 22 in FIG. 1;

FIG. 4 is a waveform diagram showing signal waveforms to be outputted from the rectifiers 21A to 21C in FIG. 3;

FIG. 5 is a block diagram showing another composition of the rectifier 21 in FIG. 1;

FIGS. 6A and 6B are circuit diagrams illustrating various power supplying systems of the data carrier 2 in FIG. 1;

FIG. 7 is a plan view showing a PDA device in a second preferred embodiment according to the invention; and

FIG. 8 is a block diagram showing the control blocks of the PDA device in FIG. 7.

### DETAILED DESCRIPTION OF THE PREFERRED EMBODIMENTS

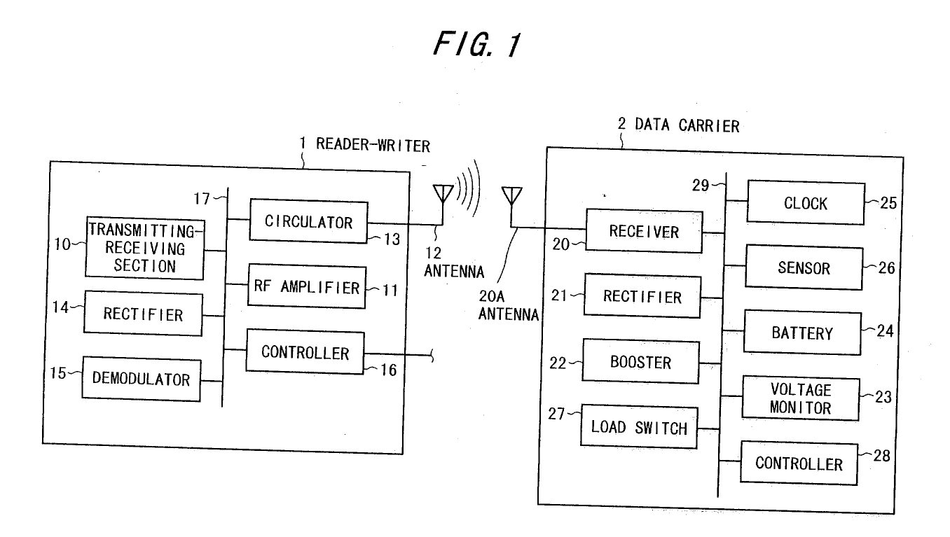

FIG. 1 schematically shows the wireless type data transmission system in the first preferred embodiment according to the invention.

In the wireless type data transmission system, a reader-writer 1 transmits a modulated wave, in which a data is modulated according to a command such as read or write, to a data carrier 2 and the data carrier 2 transmits a reflected wave, i.e., an electric wave according to the modulated wave to the reader-writer 1.

The reader-writer 1, as shown in FIG. 1, includes: a transmitter-receiver unit 10 that generates the modulated wave by modulating a carrier wave based on a transmitted data; an RF amplifier 11 that amplifies the modulated wave up to a necessary electric power and then sends it to an antenna 12; a circulator 13 that separates a modulated wave to be transmitted from the reader-writer 1 and a reflected wave to be transmitted from the data carrier 2; a rectifier 14 that rectifies a reflected wave separated by the circulator 13; a demodulator 15 that demodulates a data included in the rectified reflected wave; and a controller 16 that controls the operation of the internal circuits 10,11 and 13 to 15, which are connected through an interconnect 17 to the controller 16. The controller 16 has an interface that can be connected with an external unit (not shown) such as a keyboard, and that allows an operator to input a command thereto.

The transmitter-receiver 10 modulates a carrier wave of 2.45 GHz to be output from an oscillator(not shown) provided in the controller 16 by ASK(amplitude shift keying) modulation based on a command to the data carrier 2 to transmit a modulated wave. The command is inputted through the controller 16. After transmitting the modulated wave, it continues sending out a carrier wave during a period until when the data carrier 2 completes the transmission of data.

The data carrier 2, as shown in FIG. 1, includes: an antenna 20A; a receiver 20 that receives, through the antenna 20A, the modulated wave and carrier wave transmitted from the reader-writer 1 and demodulates the modulated wave to extract the command; a rectifier 21 that rectifies the carrier wave to generate a voltage; a booster 22 that boosts the inputted voltage to produce a high voltage; a voltage monitor 23 that monitors the level of voltage generated by the rectifier 21; a battery(secondary cell) 24 that is charged by a charge current generated according to the booster operation and supplies electric power to the respective units of the data carrier 2; a clock 25 that counts a reference clock generated by a reference clock generator(not shown) to conduct the timing operation; a sensor 26 that has a temperature sensor for measuring the temperature of a monitored object to which the data carrier 2 is attached; a load switch 27 that is driven based on a coded signal according to a transmitted data; and a controller 28 that controls the operation of the internal circuits 20 to 27, which are connected through an interconnect 29 to the controller 28.

The voltage monitor 23 monitors the level of voltage boosted by the booster 22 as well as the voltage level of the rectifier 21 descried above, and it outputs a monitor signal according to the voltage level to the controller 28.

The controller 28 has an ID storage (not shown) that stores an ID data assigned individually to the data carrier 2.

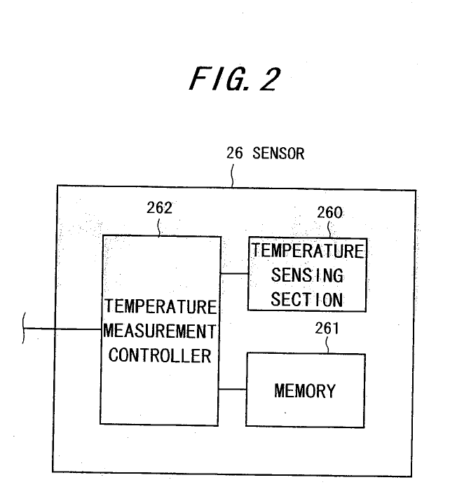

FIG. 2 shows the details of the sensor 26. The sensor 26, as shown in FIG. 2, includes: a temperature sensing unit 260 that outputs a temperature signal according to the temperature of a monitored object; a memory 261 that stores a temperature measurement data including time information obtained from the clock 25 as well as the temperature signal; a temperature measurement controller 262 that controls the operation of temperature measurement. The sensor 26 outputs the temperature measurement data from the memory 261 to controller 28, based on a data transmission command to be transmitted from the reader-writer 1. The driving voltage of the sensor 26 is supplied from the battery 24 of the data carrier 2.

The load switch 27 turns on/off according to the coded signal obtained encoding the transmitted data by the controller 28. When the load switch 27 turns on, the transmission line of electric wave becomes the same potential as the ground potential. As a result, the carrier wave is total-reflected in the reversed phase. On the contrary, when the load switch 27 turns off, the carrier wave is total-reflected in the same phase. Thus, a radio frequency signal obtained by phase-modulating the carrier wave is, as the reflected wave, transmitted to the reader-writer 1.

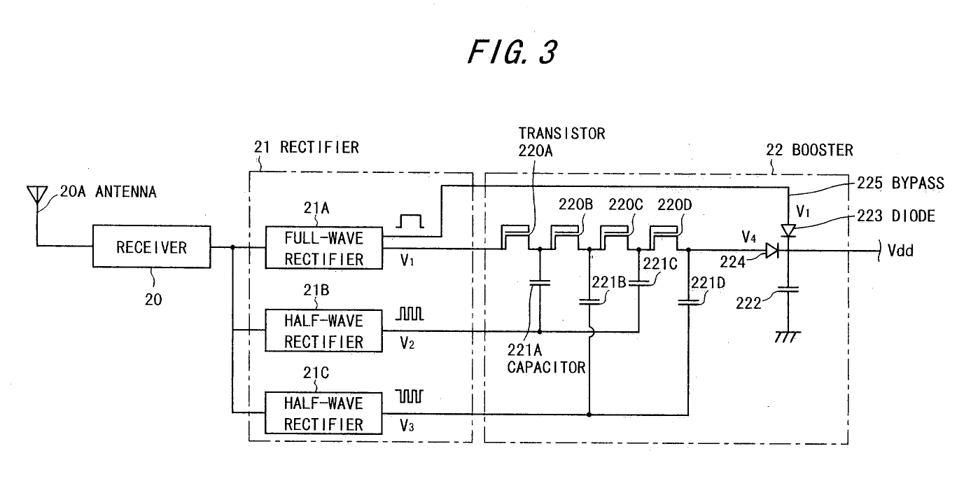

FIG. 3 shows a power supply section to supply electric power to the data carrier 2. The rectifier 21, as shown in FIG. 3, includes: a full-wave rectifier 21A that conducts the full-wave rectification of the carrier wave to be inputted through the receiver 20 so as to produce a voltage V1 with a waveform shown at the top; a half-wave rectifier 21B that conducts the half-wave rectification of the carrier wave so as to produce a voltage V2 with a waveform shown at the middle; and a half-wave rectifier 21C that conducts the half-wave rectification of the carrier wave so as to produce a voltage V3 with a waveform shown at the bottom. Although the voltage V1 is shown as a pulse form in FIG. 3 for convenience in explaining, it exactly has a continuous waveform (DC waveform). The rectifier 21 outputs the voltages V1, V2 and V3 to the booster 22.

Instead of using the full-wave rectifier 21A, the continuous wave may be produced by the half-wave doubler rectification or by smoothing the output obtained by the half-wave rectification.

The booster 22 is, as shown in FIG. 3, composed such that a charge pump circuit is formed combining a plurality of transistors 220A to 220N that are connected in series between the full-wave rectifier 21A and a diode 224 on the subsequent stage and a plurality of capacitors 221A to 221D that are connected between the nodes of the transistors and each of the half-wave rectifiers 21B and 21C. The number of transistors 220A to 220N and capacitors 221A to 221D can be suitably set according to a voltage required. Furthermore, the booster 22 includes: a bypass 225 that extends from the full-wave rectifier 21A to the subsequent stage of the diode 224 while having a diode 223; and a capacitor 222 that can be charged by charge current boosted by the charge pump circuit. The capacitors 221A to 222 may have identical capacitances.

The operation of the wireless type data transmission device will be explained below.

(1) The Transmission from the Reader-Writer 1 to the Data Carrier 2

The reader-writer 1 transmits the data transmission command to the data carrier 2 when a data transmission to the data carrier 2 is required. For example, when the data transmission command is inputted to the controller 16 by an operator, the controller 16 transmits the data transmission command to the transmitting-receiving circuit 10. The transmitting-receiving circuit 10 conducts the ASK-modulation of data transmission command and then transmits it from the antenna 12. After transmitting the command, it continues sending out the carrier wave during a period.

On the other hand, the reader-writer 1 sends out the carrier wave with a certain cycle during a period.

(2) The Transmission from the Data Carrier 2 to the Reader-Writer 1

When the data carrier 2 receives a data transmission command through the antenna 20A and receiver 20 from the reader-writer 1, it first produces a driving voltage (explained later) by the rectifier 21 and the booster 22, and outputs it to the controller 28. The controller 28 is activated from sleep state according to the inputting of the driving voltage. The receiver 20 demodulates the ASK modulated-wave to extract the data transmission command, and then outputs it to the controller 28. The controller 28 reads out an ID data based on the data transmission command from the ID storage, reads out a temperature measurement data from the memory 261 of the sensor 260, produces coded signals based on the respective data, and outputs them to the load switch 27. The load switch 27 turns on/off based on the coded signals and, thereby, sends out an electric wave, i.e., reflected wave, according to the ID data and temperature measurement data to the reader-writer 1.

(3) Power Supplying Caused by the Electric Wave Transmitted from the Data Carrier 2

The data carrier 2 receives the carrier wave through the receiver 20 from the reader-writer 1, and outputs it to the rectifier 21. The rectifier 21 rectifies the carrier wave by the full-wave rectifier 21A to generate a voltage V1, rectifies the carrier wave by the half-wave rectifiers 21B, 21C to generate voltages V2 and V3, and then outputs them to the booster 22. The booster 22 boosts the voltages V1, V2 and V3 outputted from the rectifier 21 to generate a voltage V4 that is higher than the voltages V1-V3 inputted.

In operation of the booster 22, when voltage V1 is at high level, voltage V2 is at high level and voltage V3 is at low level, the transistors 220B and 220D are activated and, thereby, charge current according to voltages V1 and V2 flows into the capacitor 221B. Also, charge current according to voltage V2 flows into the capacitor 221D. Next, when voltage V1 is at high level, voltage V2 is at low level and voltage V3 is at high level, the transistor 220C is activated and, thereby, charge current according to voltages V1, V2 and V3 flows into the capacitor 221C. Also, charge current according to voltage V2 flows into the capacitor 222. Due to these, voltage V4 on the subsequent stage of the charge pump circuit increases. Voltage V4 is smoothened by the capacitor 222 and serves as the driving voltage for the internal circuits.

Although in this embodiment MOS transistors are used as the rectifying elements, the MOS transistor may be replaced by another rectifying element such as a diode. The number of stages in the booster circuit composed of the transistors and capacitors is not limited to that shown in FIG. 3, and a suitable number of stages may be, if necessary, adopted.

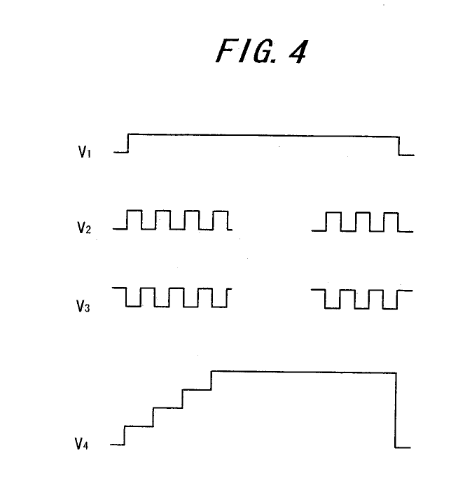

FIG. 4 shows voltage V4 generated based on voltages V1, V2 and V3. As described above, by alternating the input of voltages V2 and V3, the switching operation of the transistors 220B to 220D is repeated and, thereby, voltage V4 boosted can be obtained.

The capacitor 220 supplies part of the charge current more than the capacitance through the interconnect 29 to the battery. The battery 24 is charged by the charge current supplied.

The voltage monitor 23 monitors such that voltage V1 is supplied through the bypass 225 to the subsequent stage of the charge pump circuit without the boosting operation of the booster 22 when voltage V1 rectified by the full-wave rectifier 21A reaches a sufficient voltage level. In this case, the capacitor 222 is charged based on voltage V1 thus obtained and part of the charge current more than the capacitance is supplied through the interconnect 29 to the battery.

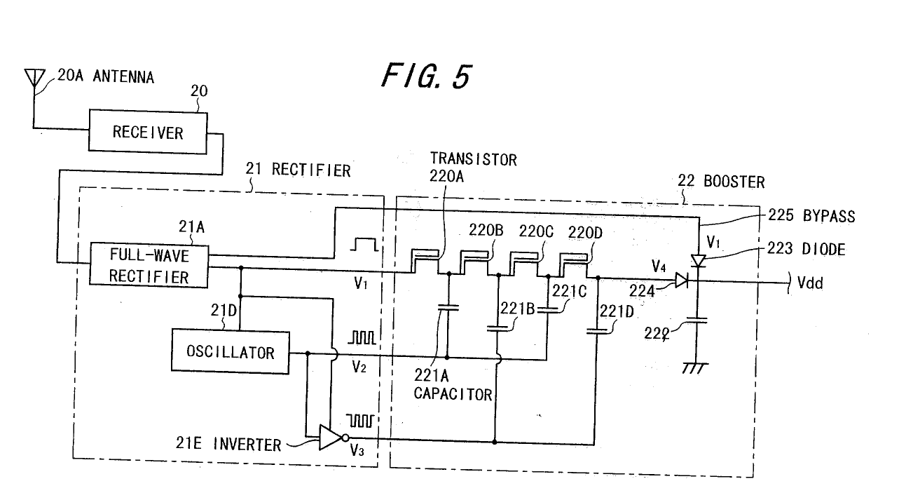

FIG. 5 shows another composition of the rectifier 21 that includes an oscillator 21D and an inverter 21E instead of the half-wave rectifiers in FIG. 3. The oscillator 21D generates pulse-like voltage V2 based on voltage V1 outputted from the full-wave rectifier 21A, and the inverter 21E generates reversed phase voltage V3 by inverting voltage V2 outputted from the oscillator 21D. The rectifier 21 thus composed outputs voltages V1, V2 and V3 to the booster 22, which generates voltage V4 that is higher than the voltages V1-V3 inputted. The composition of the booster is as explained earlier in reference to FIG. 3 and, therefore, its explanation is omitted here.

As described above, in the first embodiment of the invention, due to employing the rectifier to rectify a carrier wave and the booster to boost the voltage obtained through the rectification, a self-generation booster circuit is composed such that electric power can be self-generated based on the received electric wave and its own internal circuits can be activated based on the electric power generated. Also, due to such composition, electric power can be supplied to drive the internal circuits of the data carrier 2 and the battery 24 can be charged. As a result, without considering the life of the battery 24, the active circuits such as a temperature measurement element can be driven as well as the transmitting-receiving elements.

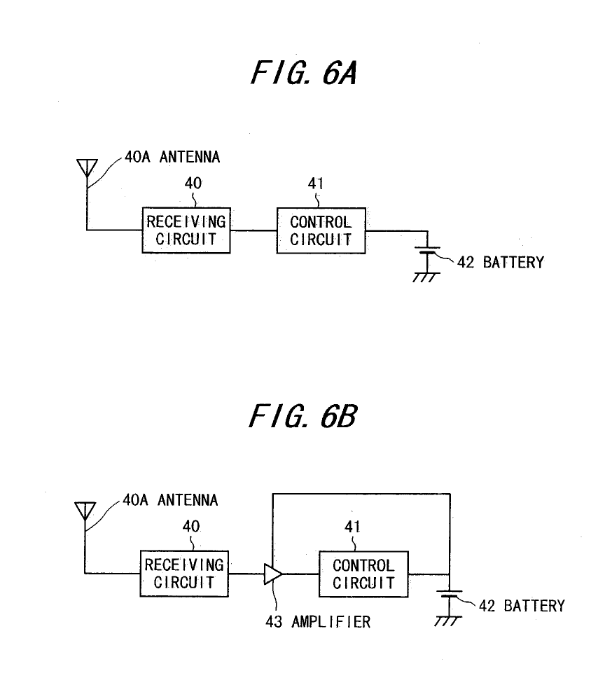

FIGS.6A and 6B schematically show a power supply system of the data carrier 2. The system includes: a receiving circuit 40 that generates electric power based on electric wave received through an antenna 40A; a control circuit 41 that conducts the processing based on the signal outputted from the receiving circuit 40 according to the received electric wave; and a battery 42 that supplies power needed to drive the control circuit 41. The control circuit 41 includes a load switch(not shown), based on the turn on/off operation of which a reflected wave is transmitted to the reader-writer 1(not shown).

In FIG. 6A, the control circuit 41 is activated when it receives voltage based on the received electric wave from the receiving circuit 40. After activating, it conducts the necessary processing by voltage supplied from the battery. Although the voltage outputted from the receiving circuit 40 depends on the intensity of electric wave, there is no problem in its operation when the received electric wave is stable in intensity. However, when the intensity of electric wave received is not sufficient, there may be caused a problem that the communications therebetween are disconnected or the distance available for communications is limited shorter since voltage enough to drive the control circuit 41 cannot be obtained.

In FIG. 6B, in order to overcome this problem, i.e., unstable voltage, there is provided, for example, an amplifier between the receiving circuit 40 and the control circuit. Thereby, voltage based on the received electric wave can be amplified by voltage supplied form the battery 42. In this composition, the control circuit 41 can be stably driven to elongate the distance available for communications, but it is necessary for the amplifier 43 to be always supplied with power. Therefore, the battery 42 will be so much consumed and may lack in electricity enough to drive the internal circuits.

In this embodiment, as described in reference to FIG. 3, voltages V1, V2 and V3 generated at the rectifier 21 based on the received electric wave are supplied to the booster 22, which can produce higher voltage V4 than voltages V1-V3 inputted by its boosting operation even when the electric wave is so weak. The boosting operation needs no electric power of the battery 24 and, therefore, the controller 28 of the data carrier 2 can be activated, regardless of the receiving state of electric wave, when the electric wave is received. Moreover, the electricity of the battery 24 is not consumed to stabilize the reception of electric wave and, therefore, it can be efficiently used to drive the internal circuits.

Furthermore, when the battery 24 is a secondary cell, it can be recharged by charge current based on voltage V4 and, therefore, there is no use restriction due to the life of battery.

The voltage monitor 23 may be controlled to supply electric power to drive the receiver 20 or sensor 26 without charging the battery 24 when voltage obtained through the rectification of the rectifier 21 is sufficient. Also, there may be provided a plurality of boosters 22, where voltage V4 boosted by a first-stage booster 22 can be further boosted by a second-stage booster 22. In this case, higher voltage can be obtained.

Although described in this embodiment is the case that the carrier wave transmitted from the reader-writer 1 is rectified, an electric wave that forms an electric field may be also used for the self-generation of electric power.

The modulation manner of data transmitted between the reader-writer 1 and the data carrier 2 may be replaced by a known modulation manner other than ASK modulation.

In recent years, as portable laptop PCs and PDAs (personal digital assistants) have been popularized, high-performance batteries or power-saving structures of internal circuit have been researched and developed to enable such a device to be driven for a long time. This invention can be suitably applied to the power supplying, charging and driving of internal circuits in such a device.

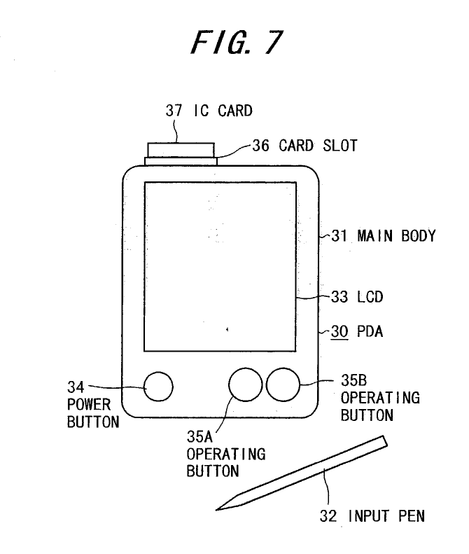

FIG. 7 shows a PDA device 30 in the second preferred embodiment according to the invention. The PDA device 30 includes: a main body 31 that has a handheld size for operator; a liquid crystal display(LCD) 33 installed in the main body 31, LCD 33 displaying an operation procedure etc. and having a pen input function that allows data input to be conducted using an input pen 32; a power button 34 used to turn on/off main power; operating buttons 35A, 35B used to operate a displayed dialogue; and a card slot 36 provided on top of the main body 31, the card slot 36 allowing a IC card 37 to be inserted thereinto.

The main body 31 includes: a controller to conduct the control operation based on a program outputted from the IC card 37; a battery as power source; and, various circuits such as described in the first embodiment, i.e., an antenna (built-in type), a receiver, a rectifier, a booster etc. The card slot 36 is, according to use, available to insert a card other than the IC card 37, e.g., a modem card for communications.

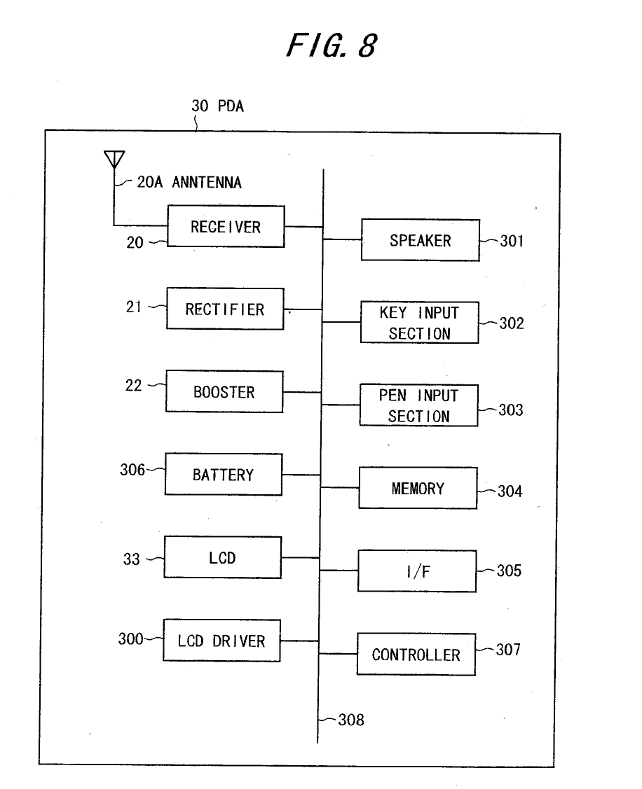

FIG. 8 shows the control blocks of the PDA device 30. The control blocks are composed of: a LCD driver 300 to drive LCD 33; a speaker 301 installed back of the main body 31; a key input section to which a signal is inputted according to the operation of the operating buttons 35A, 35B; a pen input section to which a signal is inputted according to the operation of the input pen 32; a memory 304 that stores data and programs; an interface (I/F) 305 that includes the card slot 36 and external connection terminals (not shown); a rechargeable secondary cell (battery) 306; and a controller 307 that controls the respective sections as well as monitoring the voltage level obtained rectifying a received electric wave by the rectifier 21. The. explanation of other components whose reference numbers are the same as used in the first embodiment is omitted here.

In the second embodiment, the receiver 20 receives, through the antenna 20A, an electric wave radiated in an area where cellular phones (PDAS) are available, and the rectifier 21 rectifies the electric wave to generate voltage, and then the booster 22 boosts the voltage to supply power needed to drive the LCD 33 and other circuit. When the PDA device is not in operation, the battery 306 can be charged based on charge current supplied from the booster 22. Therefore, the charging of battery can be automatically conducted without requiring the charging operation by operator. As a result, the PDA can be driven for a long time without increasing the size of the battery 306.

Such a power self-generation structure as the above data carrier 2 or PDA device 30 utilizing the received electric wave to generate electric power inside the device can be applied to other devices, e.g. a solid-state image sensing device such as a CCD image sensor that requires higher control voltage. Also, that structure can be used as a battery charging structure for emergency light or radio. Further, being applied to a backup power source for a hospital etc., the electric discharging while being not used can be avoided and, thereby, the power source can be securely backed up without requiring the charging operation by operator.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A wireless type data transmission device that generates electric power based on electric wave transmitted from a transmission device, the wireless type data transmission device comprising:
means for receiving said electric wave;
means for rectifying said received electric wave to generate a voltage; and
means for boosting said voltage to produce a driving voltage to drive an internal circuit of said wireless type data transmission device.

2. A wireless type data transmission device that generates electric power based on electric wave transmitted from a transmission device, the wireless type data transmission device comprising:
means for receiving said electric wave that is modulated according to data to be transmitted from said transmission device and for demodulating said electric wave to extract said data;
means for conducting an operation according to said extracted data;
means for rectifying said received electric wave to generate a voltage; and
means for boosting said voltage to produce a driving voltage to drive an internal circuit of said wireless type data transmission device.

3. A wireless type data transmission device according to claim 1, wherein:
said rectifying means includes a first rectifier that full-wave rectifies the received electric wave to generate a first voltage, a second rectifier that half-wave rectifies the received electric wave to generate a second voltage, and a third rectifier that half-wave rectifies the received electric wave to generate a third voltage; and
said boosting means produces the driving voltage that is boosted such that said first voltage is stepwise boosted based on the switching operating of said second and third voltages.

4. A wireless type data transmission device according to claim 2, wherein:
said rectifying means includes a first rectifier that full-wave rectifies the received electric wave to generate a first voltage, a second rectifier that half-wave rectifies the received electric wave to generate a second voltage, and a third rectifier that half-wave rectifies the received electric wave to generate a third voltage; and
said boosting means produces the driving voltage that is boosted such that said first voltage is stepwise boosted based on the switching operating of said second and third voltages.

5. A wireless type data transmission device according to claim 1, wherein:
said rectifying means includes a first rectifier that full-wave rectifies the received electric wave to generate a first voltage, an oscillator that is driven by said first voltage to generate a second voltage, and an inverter that is driven by said first voltage and inverts said second voltage to reversed phase to generate a third voltage; and
said boosting means produces the driving voltage that is boosted such that said first voltage is stepwise boosted based on the switching operating of said second and third voltages.

6. A wireless type data transmission device according to claim 2, wherein:
said rectifying means includes a first rectifier that full-wave rectifies the received electric wave to generate a first voltage, an oscillator that is driven by said first voltage to generate a second voltage, and an inverter that is driven by said first voltage and inverts said second voltage to reversed phase to generate a third voltage; and
said boosting means produces the driving voltage that is boosted such that said first voltage is stepwise boosted based on the switching operating of said second and third voltages.

7. A wireless type data transmission device according to claim 1, further comprising a secondary cell that is charged by charge current based on the driving voltage.

8. A wireless type data transmission device according to claim 2, further comprising a secondary cell that is charged by charge current based on the driving voltage.

9. A wireless type data transmission device according to claim 1, wherein:
said boosting means includes multiple stages of boosters.

10. A wireless type data transmission device according to claim 2, wherein:
said boosting means includes multiple stages of boosters.

11. A wireless type data transmission device according to claim 1, wherein:
said electric wave transmitted from said transmission device is a carrier wave.

12. A wireless type data transmission device according to claim 2, wherein:
said electric wave transmitted from said transmission device is a carrier wave.

13. A wireless type data transmission device according to claim 1, wherein:
said wireless type data transmission device is a data carrier, a PDA device, a solid-state image sensing device, an emergency lamp or radio, or backup power source.

14. A wireless type data transmission device according to claim 2, wherein:
said wireless type data transmission device is a data carrier, a PDA device, a solid-state image sensing device, an emergency lamp or radio, or backup power source.
